(19) United States
(12) Patent Application Publication
(10) Pub. No.: US 2022/0105540 A1
(43) Pub. Date: Apr. 7, 2022

(54) AQUEOUS SLURRIES, COATINGS AND COATED ARTICLES WITH HYDROPHOBIC INORGANIC PARTICLES AND METAL SALTS

(71) Applicant: THE CHEMOURS COMPANY FC, LLC, WILMINGTON, DE (US)

(72) Inventor: GUOBIN SHAN, WILMINGTON, DE (US)

(73) Assignee: THE CHEMOURS COMPANY FC, LLC, WILMINGTON, DE (US)

(21) Appl. No.: 17/423,539

(22) PCT Filed: Feb. 13, 2020
(86) PCT No.: PCT/US2020/018017

§ 371 Date: Jul. 16, 2021

Related U.S. Application Data
(60) Provisional application No. 62/805,442, filed on Feb. 14, 2019.

(51) Int. Cl. B05D 5/08; C09D 7/62; C08K 9/06; C08K 3/22; C09D 133/08; C09D 133/10

(52) U.S. Cl. CPC B05D 5/08; C09D 7/62; C08K 9/06; C08K 2003/2241; C09D 133/08; C09D 133/10; B05D 2401/20; C08K 3/22

(57) ABSTRACT

The invention relates to inorganic particle slurries and coated articles having hydrophobic inorganic particles and at least one metal salt, wherein the hydrophobic inorganic particles are inorganic particles having a hydrophobic coating selected from the group consisting of polyols, organosiloxanes, organosilanes, alkylcarboxylic acids, alkylsulfonates, organophosphates, organophosphonates, fluoropolymers, fluorosurfactants, and mixtures thereof, and wherein the metal of the metal salt is selected from the group consisting of barium, cobalt, zinc, tin, lead, copper, calcium, titanium, zirconium, magnesium, and aluminum. The combination of hydrophobic inorganic particles and metal salts provides synergistic effects in stain migration prevention, protective, and light scattering properties.

### FIELD OF THE INVENTION

This invention relates to the field of inorganic particle slurries and metal salts, including their use in polymeric coatings and coated articles.

### BACKGROUND

Substrates, such as metals, woods, and cements, commonly have aqueous pigmented coatings such as paint coatings applied for protection and/or aesthetic appeal. Inorganic particles are widely used in such polymeric coatings providing multiple functions such as opacity, pigment, color, extender, mechanic intensity, and scrub resistance. Most, if not all, aqueous coatings incorporate inorganic pigment having hydrophilic surfaces compatible with water to enhance the dispersibility of the inorganic pigment in aqueous coatings but reduce water resistance of the coating. In addition, for wood substrates, a common issue is the formation of reddish-brown or yellowing discoloration on the paint surface due to migration of tannins and/or other substances from the wood substrate through the paint film surface. This issue becomes more critical in waterborne paint systems. Particularly, the moisture will migrate and eventually carry staining substances from within the wood species to the surface of the paint film. Those colorful substances may interfere with proper penetration, absorption and/or drying properties of any future finish. Although many waterborne paint products have been claimed to have an excellent stain blocking performance, the need exists for a higher level of stain blocking performance and improved light scattering.

### SUMMARY OF INVENTION

The present invention relates to a coated article comprising a substrate and at least one coating, where the at least one coating comprises hydrophobic inorganic particles and at least one metal salt, wherein the hydrophobic inorganic particles are inorganic particles having a hydrophobic coating selected from the group consisting of polyols, organosiloxanes, organosilanes, alkylcarboxylic acids, alkylsulfonates, organophosphates, organophosphonates, fluoropolymers, fluorosurfactants, and mixtures thereof, and wherein the metal of the metal salt is selected from the group consisting of barium, cobalt, zinc, tin, lead, copper, calcium, titanium, zirconium, magnesium, and aluminum.

Another aspect of the invention relates to an aqueous slurry comprising hydrophobic inorganic particles, water, and at least one metal salt, wherein the hydrophobic inorganic particles are inorganic particles having a hydrophobic coating selected from the group consisting of polyols, organosiloxanes, organosilanes, alkylcarboxylic acids, alkylsulfonates, organophosphates, organophosphonates, fluoropolymers, fluorosurfactants, and mixtures thereof, and wherein the metal of the metal salt is selected from the group consisting of barium, cobalt, zinc, tin, lead, copper, calcium, titanium, zirconium, magnesium, and aluminum.

### DETAILED DESCRIPTION

It is understood that this invention is not limited to particular embodiments, which can, of course, vary. It is also to be understood that the terminology used herein is for the purpose of describing particular embodiments only, and is not intended to be limiting.

The present invention relates to a coated article comprising a substrate and at least one coating, where the at least one coating comprises hydrophobic inorganic particles and at least one metal salt, wherein the hydrophobic inorganic particles are inorganic particles having a hydrophobic coating selected from the group consisting of polyols, organosiloxanes, organosilanes, alkylcarboxylic acids, alkylsulfonates, organophosphates, organophosphonates, fluoropolymers, fluorosurfactants, and mixtures thereof, and wherein the metal of the metal salt is selected from the group consisting of barium, cobalt, zinc, tin, lead, copper, calcium, titanium, zirconium, magnesium, and aluminum. By the term “the at least one coating comprises hydrophobic inorganic particles and at least one metal salt”, it is meant that the hydrophobic inorganic particles and at least one metal salt may be part of the same coating; or the hydrophobic inorganic particles are in one coating and at least one metal salt are in a separate coating, both of which are present on the substrate. In other words, the series of one or more coatings must contain both the hydrophobic inorganic particles and at least one metal salt.

In one aspect, the substrate is first coated with a coating having the metal salt and is subsequently coated with a coating having the hydrophobic inorganic particles. For example, a coating having the metal salt is applied directly to the substrate, and a coating having the hydrophobic inorganic particles is applied subsequently. In this case, the coating having a metal salt may further comprise water and optional media, such as alcohols, esters, or ketones. In another aspect, the at least one coating comprises the hydrophobic inorganic particles and at least one metal salt in the same coating. In one aspect, the coating comprising the hydrophobic inorganic particles and the at least one metal salt is applied directly to the substrate. In one case, the coating having a metal salt, optionally also containing the hydrophobic inorganic particles, further comprises water and a water borne resin.

Another aspect of the invention relates to an aqueous slurry comprising hydrophobic inorganic particles, water, and at least one metal salt, wherein the hydrophobic inorganic particles are inorganic particles having a hydrophobic coating selected from the group consisting of polyols, organosiloxanes, organosilanes, alkylcarboxylic acids, alkylsulfonates, organophosphates, organophosphonates, fluoropolymers, fluorosurfactants, and mixtures thereof, and wherein the metal of the metal salt is selected from the group consisting of barium, cobalt, zinc, tin, lead, copper, calcium, titanium, zirconium, magnesium, and aluminum. In this case, both the hydrophobic inorganic particles and the at least one metal salt are part of the same composition.

The metal salt may be any compound sufficient to provide enhanced stain blocking or light scattering performance. For example, the metal salt is an organic metal salt or inorganic metal salt of barium, cobalt, zinc, tin, lead, copper, calcium, titanium, zirconium, magnesium, or aluminum. In one aspect, the metal salt is an organic metal salt selected from a metal alkoxide, metal salt of organic acid, metal salt of ester, metal sulfonate, or metal phosphonate. In one aspect, the organic metal salt is a metal acetate, metal citrate, metal oleate, metal fatty acid salt, including oleate, stearate, lactate, etc., metal isopropoxide, metal butoxide, metal acetylacetonate, metal carboxyethyl acrylate, metal acetate hydroxide, metal ethoxide, metal trifluoroacetylacetonate, metal trifluoromethanesulfonate, metal carbonate, metal glycine salt monohydrate, metal oxalate, metal ethylhexanoate, metal gluconate, metal pyrazinecarboxylate, fluorosulfonyl benzoic metal salt, metal tartrate, metal formate dihydrate, aspartic acid metal salt, or metal ascorbate. Specific examples include but are not limited to aluminum stearate, aluminum oleate, aluminum citrate, aluminum lactate, aluminum acetate, aluminum isopropoxide, zirconium(iv) butoxide, zirconium(iv) acetylacetonate, zirconium acetate, zirconium carboxyethyl acrylate, zirconium(iv) isopropoxide, zirconium(iv) acetate hydroxide, zirconium(iv) ethoxide, zirconium(iv) trifluoroacetylacetonate, ammonium zirconium(iv) carbonate, glycine zinc salt monohydrate, zinc stearate, zinc trifluoromethanesulfonate, zinc acetate, zinc citrate, zinc trifluoroacetate, orotic acid zinc salt, calcium stearate, sorbic acid calcium salt, calcium citrate, calcium propionate, calcium formate, calcium oxalate monohydrate, tin(ii) oxalate, tin(ii) 2-ethylhexanoate, tin(ii) acetate, copper(ii) d-gluconate, copper(ii) 2-pyrazinecarboxylate, 3-fluorosulfonyl benzoic copper salt, copper(ii) acetate, copper(ii) tartrate, copper(ii) 2-ethyl hexanoate, lead(ii) citrate, lead(ii) acetate, lead(iv) acetate, magnesium stearate, magnesium acetate, magnesium trifluoromethanesulfonate, magnesium formate dihydrate, magnesium citrate, aspartic acid magnesium salt, magnesium l-lactate, magnesium d-gluconate, magnesium l-ascorbate, magnesium acetate. Compounds such as metal acetates, for example, are hydrolysable and form acetates that evaporate easily at room temperature. This feature facilitates coating processing and reduces drying time. The metal salt may be present in an amount of about 0.01% to about 10.0% by weight, based on the total dry weight of the at least one coating; in another aspect, the metal salt may be present in an amount of about 0.02% to about 5.0% by weight, based on the total dry weight of the at least one coating; and in another aspect, the metal salt may be present in an amount of about 0.02% to about 1.0% by weight, based on the total dry weight of the at least one coating. “Total dry weight” is intended to mean the weight of the at least one coating excluding any evaporable liquids such as water or solvents, such as the “solids weight” of the coating. In the case of an aqueous slurry, the metal salt may be present in an amount of about 0.01% to about 10.0% by weight, based on the total weight of the aqueous slurry; in another aspect, the metal salt may be present in an amount of about 0.1% to about 5.0% by weight, based on the total weight of the aqueous slurry; and in another aspect, the metal salt may be present in an amount of about 0.5% to about 3.0% by weight, based on the total weight of the aqueous slurry.

The coated articles and slurries of the present invention include inorganic particles having hydrophobic surfaces, which are quite different from most conventional aqueous inorganic particle compositions. Typical aqueous coatings containing inorganic particles comprise inorganic particles having hydrophilic surfaces that like water and are easily dispersible in a mixture of aqueous resin. Inorganic particle surfaces may be coated with silica, zirconia, alumina, or mixtures thereof, to create particles having hydrophilic surfaces.

However, the hydrophobic inorganic particles of the present invention have a hydrophobic coating selected from the group consisting of polyols, organosiloxanes, organosilanes, alkylcarboxylic acids, alkylsulfonates, organophosphates, organophosphonates, fluoropolymers, fluorosurfactants, and mixtures thereof. For example, the fluorosurfactants may be non-polymeric fluorosurfactants. Such a hydrophobic coating lends hydrophobicity to the surface of the inorganic particles and increases the complexity of dispersing the pigments in aqueous slurries and coatings. The term hydrophobic means the surfaces of inorganic particles or part of inorganic particles in the coating are hydrophobic, i.e., the surface of the particles contains hydrophobic components. For example, the hydrophobicity of the inorganic particles may result from treatment with one or more layers of an organic compound having at least one or more nonhydrolyzable aliphatic, cycloaliphatic, fluorocarbon or aromatic groups having 6-20 carbon atoms.

In one aspect, the hydrophobic coating is at least one organosilane having the formula:

R′ₓSi(R¹)₄₋ₓ

and/or at least one polysiloxane having the formula:

$${( {R}_{n}^{2} {SiO}_{\frac{4 - n}{2}} )}_{m}$$

wherein R′ is a nonhydrolyzable aliphatic, cycloaliphatic, fluorocarbon or aromatic group having 1-20 carbon atoms; R¹ is a hydrolyzable group selected from alkoxy, halogen, acetoxy, hydroxy, or mixtures thereof; x=1 to 3; R² is an organic or inorganic group; n=0-3; and m≥2. In one aspect, R′ is a nonhydrolyzable aliphatic, cycloaliphatic, fluorocarbon or aromatic group having 6-20 carbon atoms. Examples of the organosilanes or polysiloxanes include but are not limited to octyltriethoxysilane, nonyltriethoxysilane, decyltriethoxysilane, dodecyltriethoxysilane, decyltriethoxysilane, tetradecyltriethoxysilane, pentadecyltriethoxysilane, hexadecyltriethoxysilane, heptadecyltriethoxysilane, octadecylmethoxysilane, polydimethylsiloxane, butyltrimethoxysilane, trichloro(octyl)silane, trimethoxy(3,3,3-trifluoropropyl)silane, trichloro(1H,1H,2H,2H-perfluorooctyl)silane, and 1H,1H,2H,2H-perfluorooctyltriethoxysilane.

The hydrophobic coating may be present on the inorganic particles in a continuous or discontinuous treatment and may be present at any amount necessary to allow surface hydrophobicity. In one aspect, the hydrophobic inorganic particles have about 0.01% to about 5.0% by weight of carbon on the surface from the hydrophobic coating, based on the total weight of the hydrophobic inorganic particles. In another aspect, the hydrophobic inorganic particles have about 0.05% to about 4.0% by weight of carbon on the surface from the hydrophobic coating; and in a third aspect, the hydrophobic inorganic particles have about 0.1% to about 3.0% by weight of carbon on the surface from the hydrophobic coating, based on the total weight of the hydrophobic inorganic particles. Carbon content can be measured by gas chromatographer equipped with mass spectrophotometer and infrared detector, or by elemental detector with infrared detector.

Inorganic particles used in the slurries and coated articles of the present invention include inorganic pigments, extenders, or a combination thereof, where the surfaces are coated with an organic layer to create a hydrophobic surface. Some examples of inorganic particles include, but are not limited to, titanium dioxide, silicon dioxide, aluminum oxide, aluminosilicates, aluminum hydroxide, zinc phosphate, aluminum phosphate, ZnS, BaSO₄, ZnO, CaCO₃ or MoS₂. The hydrophobic inorganic particles are present in any amount sufficient to provide light scattering and/or stain prevention properties. In one aspect, the hydrophobic inorganic particles are present in an amount of about 10% to about 90% by weight; in another aspect, about 15% to about 90% by weight; in another aspect, the hydrophobic inorganic particles are present in an amount of about 20% to about 80% by weight; and in a third aspect, the hydrophobic inorganic particles are present in an amount of about 40% to about 60% by weight, all based on the total dry weight of the at least one coating. When considering the aqueous slurry, the hydrophobic inorganic particles are present in an amount of about 40% to about 85% by weight; in another aspect, the hydrophobic inorganic particles are present in an amount of about 50% to about 80% by weight; and in a third aspect, the hydrophobic inorganic particles are present in an amount of about 60% to about 75% by weight, all based on the total weight of the aqueous slurry.

Titanium dioxide is an especially useful inorganic particle in the coated article and slurry of this invention. Titanium dioxide (TiO₂) particles useful in the present invention may be in the rutile or anatase crystalline form. The particles may be made by either a chloride process or a sulfate process. In the chloride process, TiCl₄ is oxidized to TiO₂ pigments. In the sulfate process, ore containing titanium is dissolved in sulfuric acid, and the resulting solution goes through a series of steps to yield TiO₂. Both the sulfate and chloride processes are described in greater detail in “The Pigment Handbook”, Vol. 1, 2nd Ed., John Wiley & Sons, NY (1988), the teachings of which are incorporated herein by reference. The particles may be a pigment or nanoparticle.

The titanium dioxide may be substantially pure titanium dioxide or may contain other components, such as silica, alumina, aluminosilicates, phosphates, and zirconia. These components may become incorporated into the particles and/or may be coated on the surfaces of the particles, for example, by an oxidation process and/or a precipitation process. These components may be typically about 0.1 to about 20% by weight, more typically about 0.1 to about 12% by weight, and most typically about 0.5 to about 10% by weight, based on the total pigment weight.

The particle may be washed and filtered to remove salts. The process is done in a rotary filter or a filter press. The filter cake is then dried in a spray or flash drier and the drier discharge is de-agglomerated, such as, in a hammer mill. The particle is conveyed pneumatically to a fluid energy mill, e.g. micronizer where the final de-agglomeration step is done. The hydrophobic organic treatment can be done by spraying the organic hydrophobic treatment, for example octyltriethoxysilane (neat or as an aqueous solution), at any of several locations: onto the filter cake before the hammer mill, at the micronizer (main inlet, jet nozzle and/or main outlet). The addition can take place exclusively at one location or at more than one location, and it may be done simultaneously or sequentially.

A slurry may be made by mixing the hydrophobic inorganic particles with water and optional additives with a mechanical mixer. A mechanical dispersing aid, such as zirconia beads or other solid particles, may be added during mixing and later removed. The slurry comprises hydrophobic inorganic particles, water, and at least one metal salt. The slurry may further comprise a polymeric dispersant to aid the dispersion of the hydrophobic inorganic particles in water. Such dispersants are commercially available under the tradenames TAMOL and STRODEX, such as Tamol™ 681, Tamol™ 165, or Strodex™ PK-90. The polymeric dispersants or other additives may compose up to about 5% by weight of the total weight of the aqueous slurry. Water makes up the balance of the total weight of the composition and may compose about 5% to about 59.99% by weight; in another aspect, water may compose about 15 to about 49.9% by weight; and in a third aspect, water may compose about 22% to about 39.5% by weight, all based on the total weight of the aqueous slurry.

The inorganic particles, in the form of pigments, may have an average size of less than 1 micron. Typically, pigments have an average size of from about 0.020 to about 0.95 microns, more typically from about 0.050 to about 0.75 microns and most typically about 0.075 to about 0.60 microns, as measured by Horiba LA300 Particle Size Analyzer. The inorganic particle may have a surface area of about 6 to about 150 m²/g; more typically about 6 to about 30 m²/g; and still more typically about 8 to about 15 m²/g.

Extenders, also called “extender pigments”, are typically inorganic particles having an average size of from about 0.50 to about 20 microns. Not like inorganic pigments, such as TiO₂, extender pigment itself provides little opacity. Extender pigments are added to paints to lower their cost or enhance other properties. Extenders include, but are not limited to calcium carbonate, calcium sulfate, silica, aluminosilicates, talc, and clays.

The coated articles and coating compositions of the present invention may further include a water borne resin, other inorganic particles, and/or other additives known to one skilled in the art. Such components compose the balance of the at least one coating and are present in the amount of about 0% to about 89.99% by weight; in another aspect are present in an amount of about 15% to about 79.98% by weight; and in a third aspect are present in an amount of about 39% to about 79.98% by weight, all based on the total dry weight of the at least one coating. The at least one coating and coating composition may further comprise a liquid medium, including but not limited to water, one or more organic solvents, or mixtures thereof. In one aspect, the at least one coating further comprises a water borne resin in the same coating as the hydrophobic inorganic particles. In one aspect, a coating composition comprises an aqueous slurry as described above and a water borne resin. The water borne resin is selected from the group of water-dispersible (or water borne) resins such as acrylic (latex); epoxy; alkyd; urethane; and unsaturated polyesters; and mixture thereof. The coatings of the invention may be an emulsion, latex, or a suspension of a film-forming material dispersed in an aqueous phase, and typically comprising surfactants, protective colloids and thickeners, pigments and extender pigments, preservatives, fungicides, freeze-thaw stabilizers, antifoam agents, agents to control pH, coalescing aids, and other ingredients. A coating may be exemplified by, but not limited to, pigmented coatings such as latex paints. For latex paints the film forming material is a latex polymer of acrylic, styrene-acrylic, vinyl-acrylic, ethylene-vinyl acetate, vinyl acetate, alkyd, vinyl chloride, styrene-butadiene, vinyl versatate, vinyl acetate-maleate, or a mixture thereof. Such water-dispersed coating compositions are described by C. R. Martens in “Emulsion and Water-Soluble Paints and Coatings” (Reinhold Publishing Corporation, New York, N.Y., 1965). Tex-Cote® and Super-Cote®, Rhopelx®, Vinnapas® EF500 are further examples of water based coating compositions comprising 100% acrylic resin.

The alkyd resins may be complex branched and cross-linked polyesters having unsaturated aliphatic acid residues. Urethane resins typically comprise the reaction product of a polyisocyanate, usually toluene diisocyanate, and a polyhydric alcohol ester of drying oil acids.

The water borne resin can be present in the amount of about 0 or 1% to about 89.99% by weight; in another aspect are present in an amount of about 15% to about 79.98% by weight; and in a third aspect are present in an amount of about 39% to about 79.98% by weight, all based on the total dry weight of the at least one coating or coating composition. The amount of resin is varied depending on the amount of gloss finish desired.

The hydrophobic inorganic particles, may be used alone or in combination with conventional colorants. Any conventional colorant such as a pigment, dye or a dispersed dye may be used in this disclosure to impart color to the coating composition. In one embodiment, generally, about 0.1% to about 40% by weight of conventional pigments, based on the total dry weight of the at least one coating or coating composition, can be added. In another aspect, about 0.1% to about 25% by weight of conventional pigments, based on the total dry weight of the at least one coating or coating composition, can be added.

The pigment component of this invention may be any of the generally well-known pigments or mixtures thereof used in coating formulations. Any of the conventional inorganic particles or pigments used in coating compositions can be utilized in these compositions such as the following: metallic oxides, such as titanium dioxide, zinc oxide, and iron oxide, metal hydroxide, metal flakes, such as aluminum flake, chromates, such as lead chromate, sulfides, sulfates, carbonates, carbon black, silica, talc, china clay, phthalocyanine blues and greens, organo reds, organo maroons, pearlescent pigments and other organic pigments and dyes. If desired chromate-free pigments, such as barium metaborate, zinc phosphate, aluminum triphosphate and mixtures thereof, can also be used.

A wide variety of additives may be present in the coating compositions of this invention as necessary, desirable or conventional. These compositions can further comprise various conventional paint additives, such as dispersing aids, anti-settling aids, wetting aids, thickening agents, extenders, plasticizers, stabilizers, light stabilizers, antifoams, defoamers, catalysts, texture-improving agents and/or antiflocculating agents. The amounts of such additives are routinely optimized by the ordinary skilled artisan so as to achieve desired properties in the paint, such as thickness, texture, handling, and fluidity.

Coating compositions and at the least one coating of the present invention may comprise various rheology modifiers or rheology additives (such as Acrysol®), wetting agents, dispersants and/or co-dispersants, and microbicides and/or fungicides. To achieve enhanced weatherability, the present coating compositions may further comprise UV (ultra-violet) absorbers such as Tinuvin®.

Coating compositions of the present invention may further comprise at least one solvent. Such solvents may include, for example, ketones, alcohols, esters and ethers of alcohols, aromatics, glycol ethers and esters. In an aspect of the invention such solvents can include, for example, propylene glycol n-butyl ether, dipropylene glycol n-butyl ether, tripropylene glycol n-butyl ether, 2,2,4-trimethylpentane-1,3-diol monoisobutyrate, butanol, hexanol, pentanol, octanol, 2-ethyl-1-butanol, 2-methyl-1-pentanol, 2-butoxyethanol, 2,2,4-trimethyl-1,3-pentanediol mono (2-methylpropanoate), diethylene glycol n-butyl ether acetate, diethylene glycol n-butyl ether acetate, propylene glycol phenyl ether, ethylene glycol phenyl ether, isobutyl isobutyrate, methyl isobutyl ketone, methyl ethyl ketone, 1-methoxy-2-propyl acetate (propylene glycol monomethyl ether acetate), dioctyl phthalate, texanol, and ethylene glycol.

Coating compositions of the present invention may further comprise ceramic or elastomeric substances, which are heat and/or infrared reflective, so as to provide additional heat reflective benefits.

In one aspect, the at least one coating or coating composition may contain water in an amount of about 10% to about 70% by weight; in another aspect about 10% to about 50% by weight; in another aspect, about 20% to about 40% by weight, all based on the total coating weight before drying. Any mixing means known to one skilled in the art may be used to accomplish this mixing. An example of a mixing device includes a high speed Dispermat®, supplied by BYK-Gardner, Columbia, Md.

The substrate may be any substrate requiring a stain resistant, protection, or improved-light-scattering effect. Substrates include but are not limited to metal (including steel, aluminum, etc.), wood (including pine, ash, maple, and those having high tannic content such as cedar, redwood, oak, and mahogany), wallboard, fiberboard, paper, cement, concrete, polymeric materials, composites, combinations thereof. Coatings and coating compositions of the present invention may be applied by any means known to one skilled in the art, for example, by brush, roller, sprayers including commercial grade airless sprayers, doctor blade, wiping, dipping, foaming, casting, or electrostatically in a particle coating. Coating compositions presented herein may be applied as many times necessary so as to achieve sufficient coating on a surface. Typically, these coating compositions may be applied from about 2 mils to about 10 mils wet film thickness, which is equivalent to from about 1 to about 5 dry mils film thickness. Coating compositions presented herein may be applied directly to surfaces or applied after surfaces are first coated with primers as known to one skilled in the art. The compositions of this invention may be a paint, and the paint may be applied to a surface selected from the group including of metals, woods, bridges, boats, cars, and buildings. The compositions of the present invention dry on the surface of a substrate to form a protective coating.

### EXAMPLES

Unless specified otherwise, the chemicals and materials noted in the examples are available from Sigma-Aldrich, Inc., St. Louis, Mo.

“Tamol 681” is a dispersant, ammonium salt of a hydrophobic copolymer; “Tamol 1124” is a polymeric dispersant; “Maincote HG-31” is a water-borne acrylic resin suspension; “Dowanol DPM” is a dipropylene glycol methyl ether, a coalescent; “Acrysol RM-8W” is a rheology modifier; “Acrysol DR-6600” is a rheology modifier; “Rhoplex HG-706” is a latex emulsion; “Triton N-57” is a surfactant; “Kathon LX” is a biocide; all manufactured by DOW Chemicals, Midland, Mich.

“LACPER 4312” is a paint base available from Wanhua Chemical, Philadelphia, Pa.

“Surfonyl 104DPM” is a surfactant; “Tego Foamex 825” is a defoamer; all available from Evonik Industries, Essen, Germany.

Aqueous zinc acetate (1M) is available from VWR Chemicals, Radnor, Pa.

Texanol is a coalescent agent available from Eastman Chemicals, Kingsport, Tenn.

Byk-024 is a defoamer available from BYK, Wesel, Germany.

Zirconia beads are a grinding ceramic media (ER 120, 0.6/1.0 mm) available from Saint-Gobain, Le Pontet Cedex, France.

Red oak wood samples are available from Lowes, Mooresville, N.C.

“Hydrophobic TiO₂ Pigment A” is a hydrophilic rutile TiO₂ pigment having a silica content of 3.0% by weight and an alumina content of 2.5% by weight, both based on the total weight of the TiO₂ particle, also having a hydrophobic organic treatment of octyltriethoxysilane in an amount of 0.35% by weight of carbon.

“Hydrophobic TiO₂ Pigment B” is a hydrophilic rutile TiO₂ pigment having a silica content of 3.0% by weight and an alumina content of 2.5% by weight, both based on the total weight of the TiO₂ particle, also having a hydrophobic organic treatment of octyltriethoxysilane in an amount of 0.25% by weight of carbon.

“Hydrophobic TiO₂ Pigment C” is a hydrophilic rutile TiO₂ pigment having a silica content of 3.0% by weight and an alumina content of 2.5% by weight, both based on the total weight of the TiO₂ particle, also having a hydrophobic organic treatment of octyltriethoxysilane in an amount of 0.44% by weight of carbon.

“Hydrophilic TiO₂ Pigment” is a hydrophilic rutile TiO₂ pigment having a silica content of 3.0% by weight and an alumina content of 2.5% by weight, both based on the total weight of the TiO₂ particle.

### Test Method 1—Color and Yellow Index

Reflectance readings using Tristimulas XYZ values or L*a*b* were taken of the dry coating films with a Labscan Spectro Colorimeter (Hunter Associates Lab., Inc. Reston, Va.). Treated substrates were placed inside a humidity chamber at 39° C. at 99% relative humidity for an amount of time specified in the experiments. Smaller changes in color (Δ) indicate better yellowing or stain blocking performance.

### Test Method 2—Light Scattering

Light scattering was determined using the reflectance readings taken on paint films applied to Leneta opacity charts—readings of reflectance over the white area and black area of the chart, and the substrate reflectance. Substrate reflectance was the initial reflectance of the white area of the chart, measured prior to application of the paint film. Light scattering (S, in units of square meters/gram of inorganic particle) was calculated using the reflectance readings and the equations of Kubelka-Munk.

### Test Method 3—Viscosity

Viscosity of paint is measured by a Krebs Stormer Viscometer (Model KU-1) equipped with a paddle-type spindle attachment rotating at a speed of 200 rpm.

### Test Method 4—Carbon Content Measurement

Samples of hydrophobic inorganic particles were weighed into ceramic boats and loaded into the SC632 (LECO SC632 Carbon/Sulfur Determinator (Model #620-300-100), LECO Corporation, St. Joseph, Mich.), where they combusted in the furnace (1350° C.) in a pure oxygen environment. Combustion gases were pulled through an anhydrone to scrub out water. Carbon was detected in the combustion gases by four infrared (IR) cells. The results, as % carbon by weight of the hydrophobic inorganic particle, were recorded.

### Comparative Examples A-B

Paint formulations were made by mixing the components listed in Table 1. The TiO₂ pigments used consisted of: Hydrophobic TiO₂ Pigment A (Comparative Example A) and Hydrophilic TiO₂ Pigment (Comparative Example B). Red oak wood samples were coated with the paint formulations and analyzed according to Test Method 1.

TABLE 1
Paint Formulation of Comparative Examples A-B

| Component | Mass (g) |
|---|---|
| LACPER 4312 Paint Base | 100 |
| Aqueous Ammonia (28%) | 0.2 |
| TAMOL 681 | 1.5 |
| Surfynol 104DPM | 0.7 |
| TiO₂ Pigment | 35.9 |
| Water | 10.6 |

### Example 1 and Comparative Example C

Paint formulations were made by mixing the components as listed in Table 1. The TiO₂ pigments used consisted of: Hydrophobic TiO₂ Pigment A (Example 1) and Hydrophilic TiO₂ Pigment (Comparative Example C). Red oak wood samples were sprayed with zirconium acetate (16% Zr, 50% in ethanol), dried, and then coated with the paint formulations and analyzed according to Test Method 1.

TABLE 2
Color Evaluation of Comparative Examples A-C and Example 1

| | Time in humidity chamber (hours) | | | | | | | | |
|---|---|---|---|---|---|---|---|---|---|
| | 0 | 88 | 0 | 88 | 0 | 88 | 0 | 88 | |
| Ex. | L* | L* | a* | a* | b* | b* | YI | YI | ΔYI |
| A | 98.94 | 99.05 | −0.83 | −0.87 | 1.85 | 2.03 | 2.80 | 3.11 | 0.31 |
| B | 98.87 | 98.79 | −0.93 | −0.97 | 1.93 | 2.2 | 2.89 | 3.34 | 0.45 |
| 1 | 98.82 | 98.91 | −0.84 | −0.89 | 1.76 | 1.93 | 2.64 | 2.9 | 0.25 |
| C | 98.97 | 98.91 | −0.94 | −0.97 | 1.95 | 2.22 | 2.90 | 3.37 | 0.47 |

The coating having both hydrophobic surface-treated TiO₂ and a zirconium-pretreated substrate has the lowest yellow index, as compared to the samples with only the zirconium pretreatment or only the hydrophobic surface-treated TiO₂.

### Comparative Example D and Examples 2-5

Paint formulations were made by mixing the components as listed in Table 1, using Hydrophobic TiO₂ Pigment B as the TiO₂ pigment. Red oak wood samples were sprayed with formulations according to Table 3, and the samples were dried in an oven at 120° C. for 2 hours. The treated samples were then coated with the paint formulations and analyzed according to Test Method 1.

TABLE 3
Treatment Formulation and Performance of Comparative
Example D and Examples 2-5

| | | Initial | Δb* at |
|---|---|---|---|
| Ex. | Treatment formulation | b* value | 769 hours |
| D | Deionized water | 1.91 | 0.77 |
| 2 | 0.2M MgCl₂ in water | 1.81 | 0.67 |
| 3 | 0.2M ZnCl₂ in water | 2.08 | 0.51 |
| 4 | 1M Zirconium acetate | 1.95 | 0.56 |
| | (50% in ethanol) | | |
| 5 | 0.2M AlCl₃ in water | 1.96 | 0.61 |

The table below shows that pre-treatment with a number of metal ion solutions can be used to improve yellowing resistance, as shown by reduced Δb* values.

### Comparative Example E

To a pot equipped with a Hockmeyer mixer was added 90 g of deionized water, and the mixing speed was set to 1500 rpm. Tego Foamex 825 (2.0 g), aqueous ammonia (28%, 4.0 g), Tamol 681 (18.9 g), and Surfonyl 104DPM (8.0 g) were added to the pot, and the mixing speed was adjusted to 2200 rpm. Hydrophobic TiO₂ Pigment C (440 g) was added, and the mixture was stirred at 2200 rpm for 15 minutes. The speed was decreased to 1000 rpm, and additional deionized water (50 g) was added. The mixing blade was changed, the speed was adjusted to 400 rpm, and zirconia beads (300 mL) was charged to the mixture. The mixture was mixed for 60 minutes, and the zirconia beads were removed by straining the mixture with a mesh. The resulting slurry had a solids content of 75.23% and a pH of 9.2.

### Comparative Example F

The Comparative Example E procedure was followed, using Hydrophilic TiO₂ Pigment as the TiO₂ pigment. Also, 100 g of deionized water was added to the mixture instead of 50 g. The resulting slurry had a solids content of 69.9% and a pH of 9.0.

### Comparative Example G

The Comparative Example F procedure was followed, except 85 g of deionized water was added instead of 100 g. After the zirconia beads were added, the mixture was stirred for 30 minutes, and aqueous zinc acetate (1M, 20 g) and aqueous ammonia (28%) were added to adjust to a pH of 9.0. The mixture was mixed for an additional 60 minutes before removing the zirconia beads by mesh. The resulting slurry had a solids content of 69.2% and a pH of 9.6.

### Comparative Example H

The Comparative Example G procedure was followed, except 93 g of deionized water was added instead of 85 g, and aqueous zirconium acetate solution (˜16% Zr, 8.0 g) was added in place of zinc acetate. The resulting slurry had a solids content of 68.4% and a pH of 8.2.

### Example 6

The Comparative Example E procedure was followed, except 75 g of deionized water was added instead of 50 g. After the zirconia beads were added, the mixture was stirred for 30 minutes, and aqueous zinc acetate (1M, 21.5 g) and aqueous ammonia (28%) were added to adjust to a pH of 9.0. The mixture was mixed for an additional 60 minutes before removing the zirconia beads by mesh. The resulting slurry had a solids content of 66.3% and a pH of 10.5.

### Example 7

The Comparative Example E procedure was followed, except 93 g of deionized water was added instead of 50 g. After the zirconia beads were added, the mixture was stirred for 30 minutes, and aqueous zirconium acetate (˜16% Zr, 7.5 g) and aqueous ammonia (28%) were added to adjust to a pH of 9.0. The mixture was mixed for an additional 60 minutes before removing the zirconia beads by mesh. The resulting slurry had a solids content of 68.8% and a pH of 8.2.

### Evaluation of Comparative Examples E-H and Examples 6-7

Paint formulations were mixed according to the contents in Table 4. The weight of TiO₂ slurry used was based on a 75.0% by weight solids slurry. If slurry solids did not equal 75.0%, the weight of the TiO₂ slurry was adjusted accordingly to give the same amount of TiO₂. Paint pH was adjusted to 8.8 to 9.2 by using aqueous ammonia solution, and the viscosity was adjusted to 100+/−5 Krebs Units (KU) by adding ACRYSOL RM-8W. Light scattering was measured according to Test Method 2.

TABLE 4
Paint Formulation of Comparative
Examples E-H and Examples 6-7

| Component | Mass (g) |
|---|---|
| Maincote HG-31 | 300 |
| TiO₂ slurry | 149.9 |
| (75.0% solids) | |
| Deionized Water | 15 |
| Texanol | 24.3 |
| Dowanol DPM | 8.1 |
| ACRYSOL RM-8W | 1.0 to 1.5 |
| Aqueous Ammonia | 8.8 to 9.2 |
| to adjust pH | |

TABLE 5
Light Scattering of Comparative Examples E-H and Examples 6-7

| Example | Light Scattering (m²/g) |
|---|---|
| E | 0.326 |
| F | 0.341 |
| G | 0.363 |
| H | 0.344 |
| 6 | 0.375 |
| 7 | 0.373 |

The coatings having hydrophobic surface-treated TiO₂ and metal salt compounds show the best scattering performance.

### Comparative Example I

A paint formulation was mixed according to the contents of Table 6. The resulting paint formulation (163.3 g) was mixed with a slurry of Comparative Example F (77.8 g) and deionized water (4.1 g). Light scattering was measured according to Test Method 2.

TABLE 6
Paint Formulation without TiO₂ Slurry

| Component | Mass (g) |
|---|---|
| Rhoplex HG-706 | 584.1 |
| Byk-024 | 1.0 |
| Triton N-57 | 4.6 |
| Propylene Glycol | 6.0 |
| Tamol-1124 | 1.0 |
| Kathon LX | 1.0 |
| Texanol | 7.9 |
| Aqueous Ammonia (28%) | 2.7 |
| Acrysol DR-6600 | 15 |
| Water | 30.8 |
| Byk-024 | 2.0 |

### Comparative Example J

A paint formulation was mixed according to the contents of Table 6. The resulting paint formulation (163.3 g) was mixed with a slurry of Comparative Example G (78.5 g) and deionized water (3.4 g). Light scattering was measured according to Test Method 2.

### Example 8

A paint formulation was mixed according to the contents of Table 6. The resulting paint formulation (163.3 g) was mixed with a slurry of Example 6 (81.9 g). Light scattering was measured according to Test Method 2.

### Example 9

A paint formulation was mixed according to the contents of Table 6. The resulting paint formulation (163.3 g) was mixed with a slurry of Example 7 (78.9 g) and deionized water (3.0 g). Light scattering was measured according to Test Method 2.

TABLE 7
Light Scattering of Comparative Examples I-J and Examples 8-9

| Example | Light Scattering (m²/g) |
|---|---|
| I | 0.399 |
| J | 0.394 |
| 8 | 0.431 |
| 9 | 0.461 |

The coatings having hydrophobic surface-treated TiO₂ and metal salt compounds show the best scattering performance.

1. A coated article comprising a substrate and at least one coating, where the at least one coating comprises hydrophobic inorganic particles and at least one metal salt,
wherein the hydrophobic inorganic particles are inorganic particles having a hydrophobic coating selected from the group consisting of polyols, organosiloxanes, organosilanes, alkylcarboxylic acids, alkylsulfonates, organophosphates, organophosphonates, fluoropolymers, fluorosurfactants, and mixtures thereof, and
wherein the metal of the metal salt is selected from the group consisting of barium, cobalt, zinc, tin, lead, copper, calcium, titanium, zirconium, magnesium, and aluminum.

2. The coated article of claim 1, where the metal salt is an inorganic metal salt selected from metal phosphate, metal sulfate, metal oxysulfate, metal nitrate, metal fluoride, or metal chloride.

3. The coated article of claim 1, where the metal salt is an organic metal salt selected from metal alkoxide, metal salt of organic acid, metal salt of ester, metal sulfonate, or metal phosphonate.

4. The coated article of claim 1, where the substrate is first coated with a coating having the metal salt and subsequently coated with a coating having the hydrophobic inorganic particles.

5. The coated article of claim 1, where the at least one coating comprises the inorganic particles and at least one metal salt in the same coating.

6. The coated article of claim 1, where the hydrophobic inorganic particles have about 0.01% to about 5.0% by weight of carbon on the surface from the hydrophobic coating, based on the total weight of the hydrophobic inorganic particles.

7. The coated article of claim 1, where the metal salt is present in an amount of about 0.01% to about 10.0% by weight, based on the total dry weight of the at least one coating.

8. The coated article of claim 1, where the hydrophobic coating is an organosilane or an organosiloxane.

9. The coated article of claim 8, where the hydrophobic coating is at least one organosilane having the formula:
R′ₓSi(R¹)₄₋ₓ
and/or at least one polysiloxane having the formula:
$${( {R}_{n}^{2} {SiO}_{\frac{4 - n}{2}} )}_{m}$$
wherein
R′ is a nonhydrolyzable aliphatic, cycloaliphatic, fluorocarbon or aromatic group having 1-20 carbon atoms;
R¹ is a hydrolyzable group selected from alkoxy, halogen, acetoxy, hydroxy, or mixtures thereof;
x=1 to 3;
R² is an organic or inorganic group;
n=0-3; and
m≥2.

10. The coated article of claim 1, where the inorganic particles are selected from titanium dioxide, silicon dioxide, aluminum oxide, aluminosilicates, aluminum hydroxide, zinc phosphate, aluminum phosphate, ZnS, BaSO₄, ZnO, CaCO₃ or MoS₂.

11. The coated article of claim 1, where the at least one coating further comprises a water borne resin in the same coating as the hydrophobic inorganic particles, said water borne resin selected from the group consisting of acrylic, alkyd, urethanes, epoxy, unsaturated polyesters, and mixtures thereof.

12. The coated article of claim 11, where the water borne resin is present in an amount of about 1% to about 89.99% by weight of the at least one coating.

13. The coated article of claim 1, where the substrate is metal, wood, wallboard, fiberboard, paper, cement, concrete, polymeric materials, paper, composites, or combinations thereof.

14. The coated article of claim 1, wherein the hydrophobic inorganic particles are present in an amount of about 10% to about 90% by weight, based on the total dry weight of the at least one coating.

15. An aqueous slurry comprising hydrophobic inorganic particles, water, and at least one metal salt,
wherein the hydrophobic inorganic particles are inorganic particles having a hydrophobic coating selected from the group consisting of polyols, organosiloxanes, organosilanes, alkylcarboxylic acids, alkylsulfonates, organophosphates, organophosphonates, fluoropolymers, fluorosurfactants, and mixtures thereof, and
wherein the metal of the metal salt is selected from the group consisting of barium, cobalt, zinc, tin, lead, copper, calcium, titanium, zirconium, magnesium, and aluminum.

16. The aqueous slurry of claim 15, where the metal salt is an inorganic metal salt selected from metal phosphate, metal sulfate, metal oxysulfate, metal nitrate, metal fluoride, or metal chloride.

17. The aqueous slurry of claim 15, where the metal salt is an organic metal salt selected from metal alkoxide, metal salt of organic acid, metal salt of ester, metal sulfonate, or metal phosphonate.

18. The aqueous slurry of claim 15, where the hydrophobic inorganic particles have about 0.01% to about 5.0% by weight of carbon on the surface from the hydrophobic coating, based on the total weight of the hydrophobic inorganic particles.

19. The aqueous slurry of claim 15, where the metal salt is present in an amount of about 0.01% to about 10.0% by weight, based on the total weight of the aqueous slurry.

20. The aqueous slurry of claim 15, where the hydrophobic coating is an organosilane or an organosiloxane.

21. The aqueous slurry of claim 15, where the hydrophobic coating is at least one organosilane having the formula:
R′ₓSi(R¹)₄₋ₓ
and/or at least one polysiloxane having the formula:
$${( {R}_{n}^{2} {SiO}_{\frac{4 - n}{2}} )}_{m}$$
wherein
R′ is a nonhydrolyzable aliphatic, cycloaliphatic, fluorocarbon or aromatic group having 1-20 carbon atoms;
R¹ is a hydrolyzable group selected from alkoxy, halogen, acetoxy, hydroxy, or mixtures thereof;
x=1 to 3;
R² is an organic or inorganic group;
n=0-3; and
m≥2.

22. The aqueous slurry of claim 15, where the inorganic particles are selected from titanium dioxide, silicon dioxide, aluminum oxide, aluminosilicates, aluminum hydroxide, zinc phosphate, aluminum phosphate, ZnS, BaSO₄, ZnO, CaCO₃ or MoS₂.

23. The aqueous slurry of claim 15, wherein the hydrophobic inorganic particles are present in an amount of about 40% to about 85% by weight, based on the total weight of the slurry.

24. The aqueous slurry of claim 15, further comprising a polymeric dispersant.

25. A coating composition comprising the aqueous slurry of claim 15 and a water borne resin, said water borne resin selected from the group consisting of acrylic, alkyd, urethanes, epoxy, unsaturated polyesters, and mixtures thereof.
